(19) United States
(12) Patent Application Publication
(10) Pub. No.: US 2015/0376941 A1
(43) Pub. Date: Dec. 31, 2015

(54) COVERING FOR AN ARCHITECTURAL OPENING

(71) Applicant: HUNTER DOUGLAS INC., Pearl River, NY (US)

(72) Inventors: Suzanne M. Fujita, Louisville, CO (US); William S. Certain, Westminster, CO (US); Stephen M. Winters, Erie, CO (US); Kenneth M. Faller, Thornton, CO (US); Stephen P. Smith, Denver, CO (US)

(21) Appl. No.: 14/769,127

(22) PCT Filed: Mar. 15, 2013
(86) PCT No.: PCT/US13/32224

§ 371 Date: Aug. 20, 2015

(51) Int. Cl. E06B 9/60; E06B 9/58; E06B 9/40

(52) U.S. Cl. CPC E06B 9/60; E06B 9/40; E06B 9/58; E06B 2009/405

(57) ABSTRACT

A covering for an architectural opening is provided. The covering may include a head rail, a first roller rotatably supported by the head rail, a second roller rotatably supported by the head rail, a first shade attached to the first roller, and a second shade attached to the second roller. The second roller may be positioned rearward of the first roller. The first shade may be wrappable about the first roller. The first shade may include two laterally-separable sheets interconnected by a plurality of vertically-spaced vanes. The second shade may be wrappable about the second roller.

### FIELD

The present disclosure relates generally to coverings for architectural openings.

### BACKGROUND

Coverings for architectural openings, such as windows, doors, archways, and the like, have taken numerous forms for many years. Some coverings include a retractable shade that is movable between an extended position and a retracted position. In the extended position, the shade of the covering may be positioned across the opening. In the retracted position, the shade of the covering may be positioned adjacent one or more sides of the opening.

### SUMMARY

Examples of the disclosure may include a covering for an architectural opening. The covering may include a head rail, a first roller rotatably supported by the head rail, a second roller rotatably supported by the head rail and positioned rearward of the first roller, a first shade attached to the first roller and wrappable about the first roller, and a second shade attached to the second roller and wrappable about the second roller. The first shade may include two laterally-separable sheets interconnected by a plurality of vertically-spaced vanes. The covering may further include a limit screw positioned within at least one of the first or second rollers and a limit stop operably associated with the limit screw. The limit stop may include a first member threaded onto the limit screw and defining a first keyed structure, and a second member slidably keyed onto the limit screw and defining a second keyed structure in opposing relationship to, and slidably engagable with, the first keyed structure. The first and second keyed structures comprise corresponding longitudinally-extending splines. The second member may include a resilient, cantilevered finger that selectively engages an external thread of the limit screw.

The covering may further include a tube positioned within at least one of the first or second rollers and defining an aperture extending (such as transversely) through a wall of the tube, and a stop element extending at least partially through the aperture. The stop element may includes a first leg positioned radially between the tube and the at least one of the first or second rollers, a second leg positioned within the tube, and a riser extending through the aperture and interconnecting the first and second legs. The first and second legs may extend longitudinally along a portion of the tube. The first and second legs may extend in opposing directions relative to one another. The first and second legs may be oriented substantially parallel to one another. The head rail may include an end cap, the second shade may include a bottom rail having a flange attached to, and extending longitudinally away from, an end of the bottom rail, and the flange may interact with the end cap to set a retraction limit of the second shade. The end cap may include a cord guide and the flange may interact with the cord guide, which may set the retraction limit of the second shade. The end cap may include a wing positioned rearward of the second shade. The wing may extend longitudinally beyond an edge of the second shade. The first and second shades may be substantially concealed within the head rail when in a retracted position. The second roller may be positioned higher than the first roller within the head rail.

In another example, the covering may include a rotatable roller, an externally-threaded shaft positioned within the roller, a travelable nut threaded onto the shaft and keyed to the roller, and a stop associated with the shaft. The stop may be adjustable or movable. The stop may include an adjustment member threaded onto the shaft and defining a first key pattern and a lock member slidably keyed onto the limit screw and defining a second key pattern in opposing relationship to, and slidably engagable with, the first key pattern. The first and second key patterns may be corresponding longitudinally-extending splines. The adjustment member may be externally splined, and the lock member may be internally splined. The lock member may include a resilient, cantilevered finger that selectively engages an external thread of the shaft. The covering may further include an immovable stop, and the travelable nut may be positioned between the immovable stop and the stop. The covering may further include a shade suspended from the roller. The shade may include two laterally-separable sheets interconnected by a plurality of vertically-spaced vanes.

In a further example, the covering may include an outer tube, an inner tube positioned within the outer tube and defining an aperture extending through a wall of the tube, an externally-threaded shaft positioned within the inner tube, a travelable nut threaded onto the shaft and keyed to the inner tube, and a stop element positioned within the outer tube and extending at least partially through the aperture. The stop element may include a first portion positioned radially between the outer tube and the inner tube, a second portion positioned within the inner tube, and an intermediate portion extending through the aperture and interconnecting the first and second portions. The first and second portions may extend longitudinally along a length of the inner tube. The first and second portions may extend in opposing directions relative to one another. The first and second portions may be substantially parallel to one another.

This summary of the disclosure is given to aid understanding, and one of skill in the art will understand that each of the various aspects and features of the disclosure may advantageously be used separately in some instances, or in combination with other aspects and features of the disclosure in other instances. Accordingly, while the disclosure is presented in terms of examples, it should be appreciated that individual aspects of any example can be claimed separately or in combination with aspects and features of that example or any other example.

This summary is neither intended nor should it be construed as being representative of the full extent and scope of the present disclosure. The present disclosure is set forth in various levels of detail in this application and no limitation as to the scope of the claimed subject matter is intended by either the inclusion or non-inclusion of elements, components, or the like in this summary. Moreover, reference made herein to “the present invention” or aspects thereof should be understood to mean certain examples of the present disclosure and should not necessarily be construed as limiting all examples to a particular description.

### BRIEF DESCRIPTION OF THE DRAWINGS

The accompanying drawings, which are incorporated in and constitute a part of the specification, illustrate examples of the disclosure and, together with the general description given above and the detailed description given below, serve to explain the principles of these examples.

FIGS. 1A, 1B, and 1C are isometric views of a covering with two shades in a fully-extended position, a partially-extended position, and a fully-retracted position, respectively.

FIGS. 2A, 2B, and 2C are transverse section views the covering of FIGS. 1A, 1B, and 1C taken along the lines 2A-2A, 2B-2B, and 2C-2C as illustrated in FIGS. 1A, 1B, and 1C, respectively.

FIG. 3 is a partially exploded, isometric view of an example head rail assembly of the covering of FIGS. 1A-1C.

FIG. 4 is another partially exploded, isometric view of the head rail assembly of FIG. 3.

FIG. 5 is a front elevation view of a dual limit assembly of the head rail assembly of FIG. 3 in a first position, which may correspond to a fully-extended shade position.

FIG. 6 is a lengthwise section view of the dual limit assembly of FIG. 5 taken along the line 6-6 as illustrated in FIG. 5.

FIG. 7 is a front elevation view of the dual limit assembly of FIG. 5 in a second position, which may correspond to a fully-retracted shade position.

FIG. 8 is an exploded, isometric view of a limit screw, a travelable nut, a bottom stop, and a top stop of the dual limit assembly of FIG. 5.

FIG. 9 is another exploded, isometric view of the limit screw, the travelable nut, the bottom stop, and the top stop of FIG. 8.

FIG. 10 is a flow chart of a method of setting a top stop of the dual limit assembly of FIG. 5.

FIG. 11 is a partially exploded, isometric view of another example head rail assembly.

FIG. 12 is an isometric view of an end stop of the head rail assembly of FIG. 11.

FIG. 13 is a side elevation view of the end stop of FIG. 12.

FIG. 14 is a top plan view of an operating system of the head rail assembly of FIG. 11.

FIG. 15 is a lengthwise section view of the operating system of FIG. 11 taken along the line 15-15 as illustrated in FIG. 14.

FIG. 16 is a transverse section view of the operating system of FIG. 11 taken along the line 16-16 as illustrated in FIG. 14.

FIG. 17 is an enlarged view of the operating system of FIG. 11 taken along the line 17-17 as illustrated in FIG. 16.

It should be understood that the drawings are not necessarily to scale. In certain instances, details that are not necessary for an understanding of the disclosure or that render other details difficult to perceive may have been omitted. In the appended drawings, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label. It should be understood that the claimed subject matter is not necessarily limited to the particular examples or arrangements illustrated herein.

### DETAILED DESCRIPTION

The present disclosure provides a covering for an architectural opening. The covering may include a head rail, one or more rollers rotatably supported by the head rail, and one or more shades attached to the one or more rollers. In one example, the covering includes dual rollers offset from one another laterally, vertically, or both. The dual rollers may be concealed within and rotatably supported by the head rail. The dual rollers may be associated with separate shades such that rotation of the rollers moves the shades. The dual rollers may be independently controlled by distinct operating systems, which may be associated with the same end or different ends of the head rail. To limit the amount of travel of a shade, the covering may include a limit or stop system that may include an extension stop, a retraction stop, or both.

In one example, one of the stops may be associated with a bottom rail attached to a lower edge of a shade. The bottom rail may extend along substantially the entire width of the shade. The bottom rail may have a length defined between two terminal ends and may include a protrusion (such as a flange, knob, or other protruding feature) that extends longitudinally outward from one or both ends of the bottom rail. During retraction of the shade, the protrusion may abut, contact, engage, or otherwise interact with an abutment surface (such as a corresponding flange, knob, or other abutment feature) associated with an end cap of the head rail. The feature may be integral with or removable from the end cap. The abutment surface may be positioned within the retraction path of the protruding feature of the bottom rail, and thus the interaction between the abutment surface and the protruding feature of the bottom rail may substantially prevent retraction of the bottom rail beyond the abutment surface, thereby providing a retraction or top-end stop of the shade. To ensure proper alignment between the protruding feature of the bottom rail and the abutment surface of the end cap, a guide may be associated with the end cap. The guide may be formed as a post, wing, tab, or other guiding feature. The guide may be laterally adjacent the abutment surface and may extend longitudinally beyond a portion of the shade.

In another example, one of the stops may be associated with a limit screw or threaded shaft positioned within a tube. The stop may be adjustable or movable along a length of the limit screw to permit an assembler, installer, and/or operator to set the stop based on the dimensions of an associated architectural opening. The stop may include two components: a first stop member and a second stop member. The first stop member may be threaded onto the shaft and travelable along a length of the shaft. The second stop member may be slidably keyed onto the shaft and travelable along the length of the shaft.

To set the stop relative to the shaft, the first stop member may be translated along a length of the shaft by rotating the first stop member relative to the shaft. Once the first stop member is translated to a desired stop position along the shaft (based on the dimensions of the architectural opening), the second stop member may be translated along a length of the shaft toward the first stop member by sliding the second stop member relative to the shaft and to the second stop member. The first and second stop members may include confronting keying patterns or structures that may be complementary to one another. Thus, upon rotational alignment of the corresponding keying patterns or structures, the second stop member may be slid into keyed engagement with the first stop member to substantially prevent further rotation of the first stop member relative to the shaft.

To substantially prevent the second stop member from sliding axially away from the first stop member along a length of the shaft (which may result in disengagement of the first and second stop members), the second stop member may be limited to axial movement along the shaft in substantially one direction. For example, the second stop member may include a ratchet mechanism operably associated with an external thread of the shaft or may include other suitable movement restraining devices. As such, the first and second stop members may be locked together to substantially anchor the stop to the shaft.

The keying pattern or structure may include various corresponding configurations and shapes. For example, one of the first or second stop members may include a shaft having a polygonal transverse cross-section and the other of the first or second stop members may include a shaft receptacle with a corresponding transverse cross-section. As another example, the first and second stop members may include complementary splines. Other example keying patterns or structures may be used.

In another example, one of the stops may be associated with a tube that is inserted within another tube. The stop may be removably attached to a wall of the inner tube. At least a portion of the stop may protrude into a path of a travelable nut positioned within and associated with a limit screw. The travelable nut may be non-rotatably keyed to the inner tube and thus rotation of the nut may be linked to rotation of the tube, and vice versa. By obstructing the translation of the travelable nut along a limit screw within the inner tube, the stop may set a rotational limit for the tube and a shade associated with the

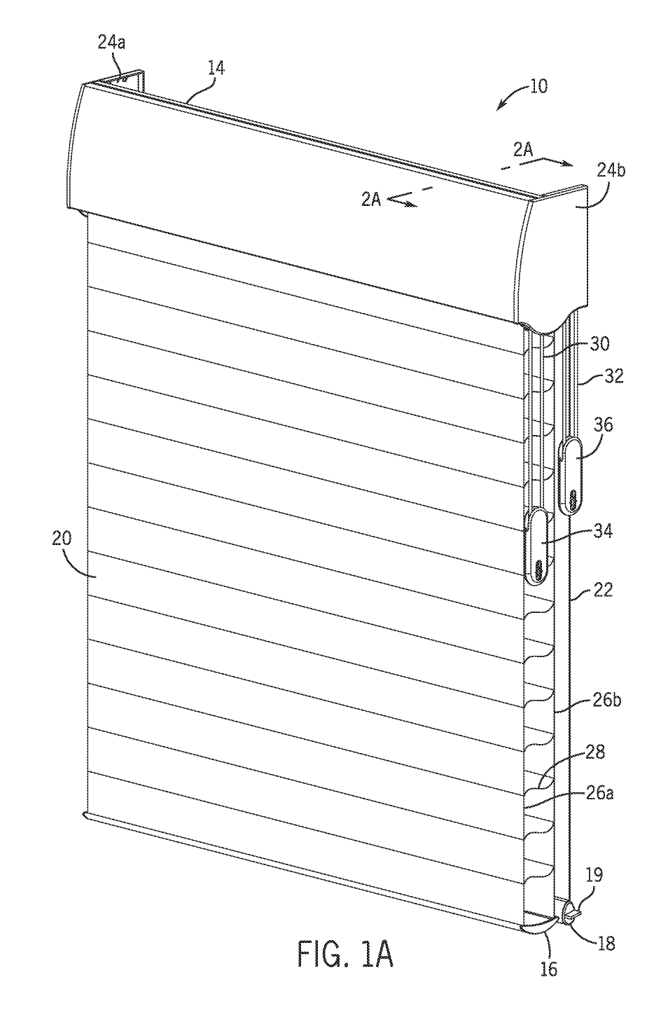

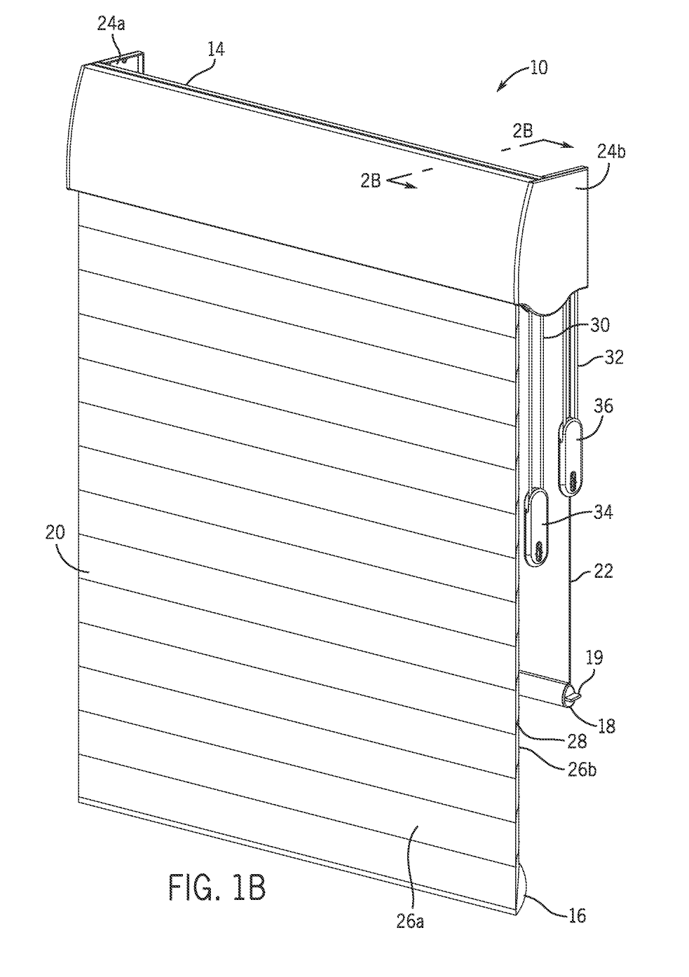

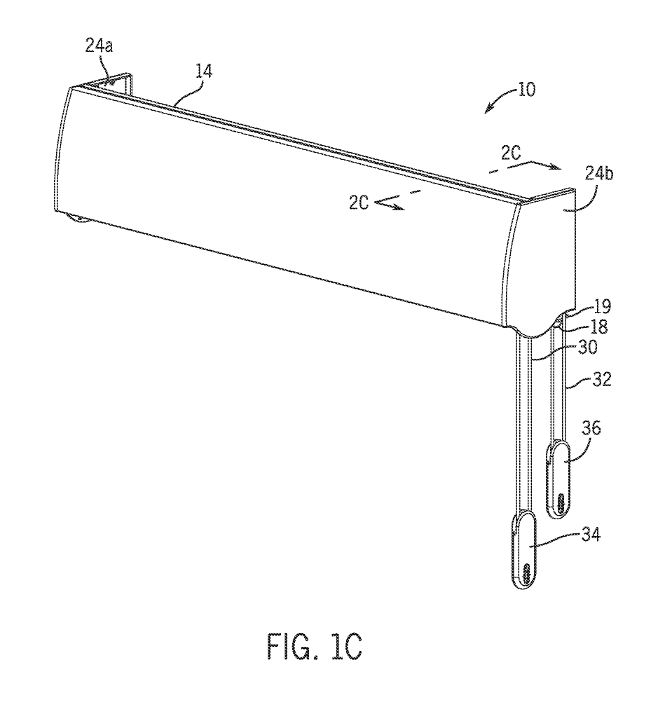

Referring to FIGS. 1A-1C, a retractable covering 10 for an architectural opening is provided. The retractable covering 10 may include a head rail 14, bottom rails 16, 18, and shades 20, 22 extending between the head rail 14 and respective bottom rails 16, 18. The head rail 14 may include two opposing end caps 24a, 24b, which may enclose the ends of the head rail 14 to provide a finished appearance. The bottom rails 16, 18 may extend substantially horizontally along a lower edge of the respective shades 20, 22 and may function as a balast to maintain the shades 20, 22 in a taut condition. Although not depicted, the head rail 14 may include a top cover, a rear cover, or both.

The shade 20 may be a Silhouette® shade. The shade 20 may include vertically suspended front 26a and rear 26b sheets of flexible material (such as sheer fabric) and a plurality of horizontally-extending, vertically-spaced flexible, semi-rigid, or rigid vanes 28. Each of the vanes 28 may be secured along horizontal lines of attachment with a front edge attached to the front sheet 26a and a rear edge attached to the rear sheet 26b. The sheets 26a, 26b and vanes 28 may form a plurality of elongated, vertically-aligned, longitudinally-extending, transversely-collapsible cellular units which are longitudinally secured, such as adhered, to adjacent cellular units to define a vertical stack of cellular units, which may be referred to as a cellular panel. The sheets 26a, 26b and/or the vanes 28 may be constructed of continuous lengths of material or may be constructed of strips of material attached or joined together in an edge-to-edge, overlapping, or other suitable relationship.

The shade 22 may be a blackout shade. The shade 22 may include a panel or sheet of flexible material. The shade 22 may be constructed of continuous lengths of material or may be constructed of strips of material attached or joined together in an edge-to-edge, overlapping, or other suitable relationship. The shade 22 may be constructed of multiple layers of material. One or more layers may be formed of a blackout material. For example, the shade 22 may include a stretched polyester film, such as a stretched polyethylene terephthalate (PET) film or foil, which is generally known as biaxially-oriented polyethylene terephthalate.

The shades 20, 22 may be constructed of substantially any type of material. For example, the shades 20, 22 may be constructed from natural and/or synthetic materials, including fabrics, polymers, and/or other suitable materials. Fabric materials may include woven, non-woven, knits, or other suitable fabric types. The shades 20, 22 may have any suitable level of light transmissivity. For example, the shade 20, including the sheets 26a, 26b and/or the vanes 28, may be constructed of transparent, translucent, and/or opaque materials to provide a desired ambience or decor in an associated room. In one example, the sheets 26a, 26b are transparent and/or translucent, and the vanes 28 are translucent and/or opaque. Similar to the shade 20, the shade 22 may be constructed of transparent, translucent, and/or opaque materials. In one example, the shade 22 is opaque and substantially blocks light passage.

The shades 20, 22 may be controlled individually or jointly. In some implementations, each shade 20, 22 may be individually operated by a common type of operating system, which may be associated with the same end or different ends of the head rail 14. In some implementations, each shade 20, 22 may be individually operated by a different type of operating system, which may be associated with the same end or different ends of the head rail 14. With continued reference to FIGS. 1A-1C, separate operating elements 30, 32 (such as cords or ball chains) may be operably associated with the shades 20, 22 to independently control or move the shades 20, 22. The operating elements 30, 32 may be associated with the same end of the head rail 14 (as depicted) or different ends of the head rail 14. An operating element restraint or tensioner 34, 36 may be associated with a lower end of the operating elements 30, 32 to maintain the operating elements 30, 32 in a taut condition.

The shades 20, 22 may be movable between extended and retracted positions, as illustrated in FIGS. 1A-1C. With reference to FIG. 1A, the shades 20, 22 are illustrated in an extended position in which the first or front shade 20 is opened or expanded and the second or rear shade 22 is substantially parallel to the sheets 26a, 26b of the first shade 20. In this position, the front and rear sheets 26a, 26b of the first shade 20 may be laterally spaced from one another and the vanes 28 may extend substantially horizontally between the sheets 26a, 26b. The bottom rails 16, 18 of the shades 20, 22 may be substantially horizontally aligned with one another. From the first shade 20 position depicted in FIG. 1, retraction of the first shade 20 may move the front and rear sheets 26a, 26b relative to one another in generally opposing vertical directions to shift the vanes 28 from an open position to a closed position.

The first and second shades 20, 22 may be independently movable relative to one another. With reference to FIG. 1B, the shades 20, 22 are illustrated in another extended position in which the shades 20, 22 are retracted relative to FIG. 1A. In this retracted position, the first shade 20 is in a closed or collapsed position in which the front and rear 26a, 26b are relatively close to one another and the vanes 28 extend substantially vertically in an approximately coplanar, contiguous relationship with the front and rear sheets 26a, 26b. The second shade 22 may be oriented substantially parallel to the front sheet 26a, the rear sheet 26b, the vanes 28, or a combination thereof. To illustrate the independent motion of the first and second shades 20, 22, the second shade 22 has been retracted more than the first shade 20 and thus the bottom rail 18 of the second shade 22 is positioned vertically higher than the bottom rail 16 of the first shade 20. With reference to FIG. 1C, the shades 20, 22 have been retracted into a substantially fully retracted position. In this position, the shades 20, 22 may be substantially concealed within the head rail 14.

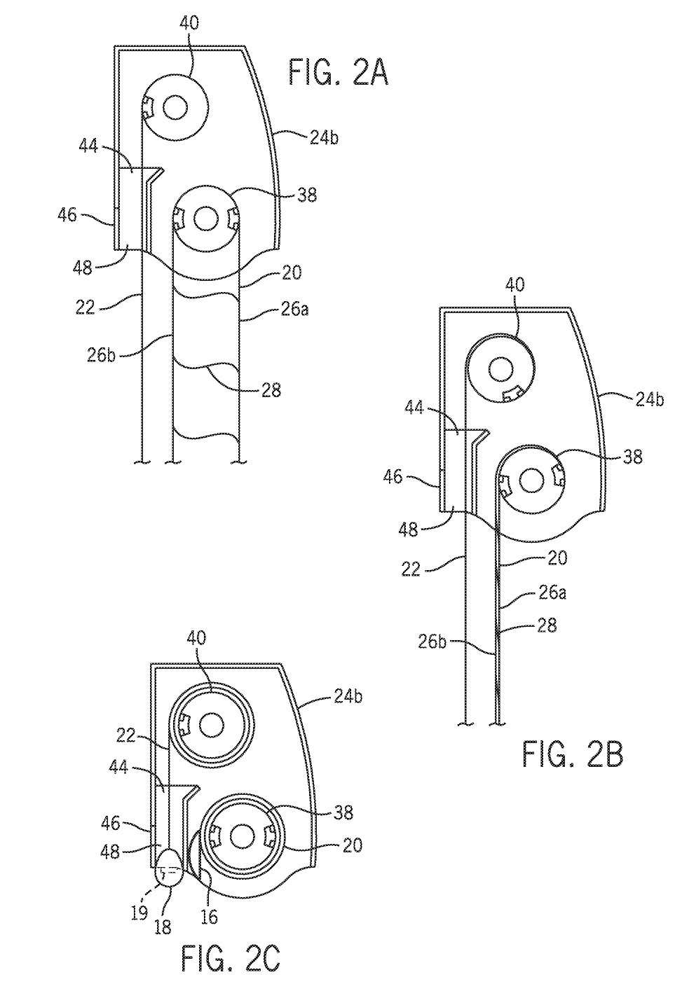

With reference to FIGS. 2A-2C, the covering 10 may include double or dual rollers 38, 40, which may be offset from one another in lateral and/or vertical directions. The rollers 38, 40 may be substantially concealed within the head rail 14. The first roller 38 may be positioned forward of the second roller 40 within the head rail 14. Additionally or alternatively, the first roller 38 may be positioned lower than the second roller 40 within the head rail 14. The first shade 20 may be attached to the first roller 38, and the second shade 22 may be attached to the second roller 40. The depth and height of the head rail 14 may be modified to accommodate different applications. In one implementation, the depth of the head rail 14 is between about 3 inches and about 6 inches. In one implementation the depth of the head rail 14 is about 4 inches. The rollers 38, 40 may be positioned within the head rail 14 such that the rollers 38, 40 may individually support and the head rail 14 may substantially conceal various drop lengths of the shades 20, 22. In one implementation, the rollers 38, 40 may individually support and the head rail 14 may substantially conceal up to and exceeding 200 inches of drop length of the shades 20, 22. In one implementation, the rollers 38, 40 individually support and the head rail 14 substantially conceals about 110 inches of drop length of the shades 20, 22.

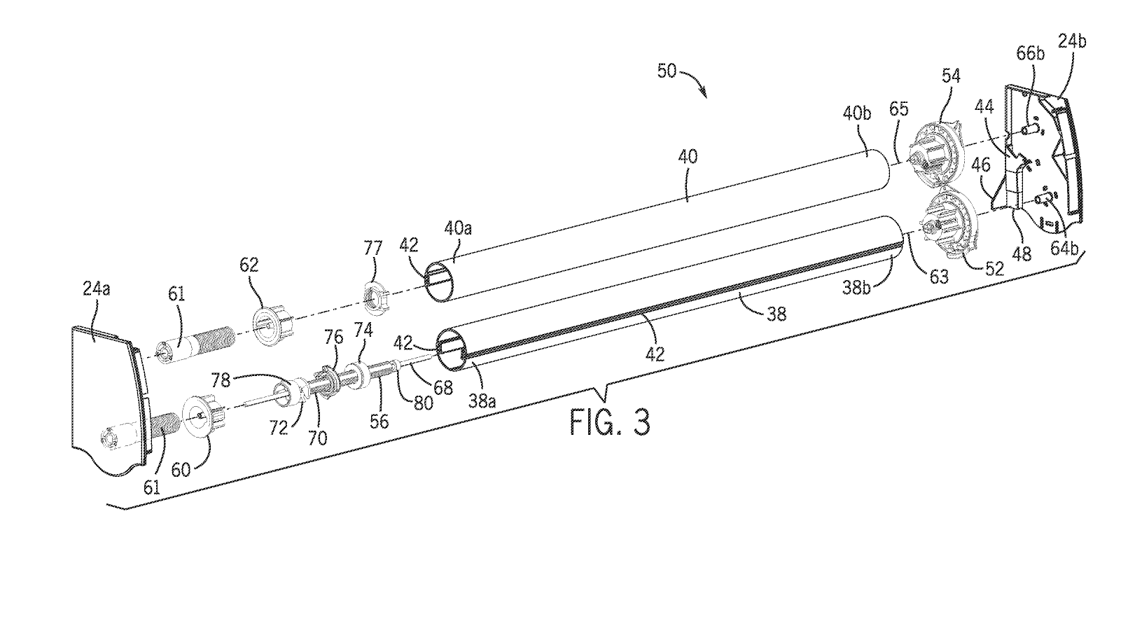

The shades 20, 22 may be operably associated with the respective rollers 38, 40 so that rotational movement of the rollers 38, 40 about respective longitudinally-extending axes moves the shades 20, 22 between extended and retracted positions. For instance, the shades 20, 22 may be coupled to and wrappable about the rollers 38, 40 so that rotation of the rollers 38, 40 in a first direction may retract the shades 20, 22 to a position adjacent one or more sides of an associated architectural opening and rotation of the rollers 38, 40 in a second, opposite direction may extend the shades 20, 22 across the opening. As shown in FIGS. 2A-3C, the shades 20, 22 may be wrapped about or unwrapped from a rear side of the rollers 38, 40, with the rear side of the rollers 38, 40 positioned between a front side of the respective roller 38, 40 and a street side of an associated architectural opening. Alternatively, either or both of the shades 20, 22 may be wrapped about or unwrapped from the front side of the rollers 38, 40. An upper edge of each of the front and rear sheets 26a, 26b of the first shade 20 and an upper edge of the second shade 22 may be coupled to an inwardly-directed, longitudinally extending gland or rib 42. The gland 42 may define an internal cavity that opens through a periphery of the rollers 38, 40. The internal cavity of the gland 42 may be configured to receive an upper edge of the shades 20, 22, each of which may be hemmed and include a strip of material extending longitudinally within a hem-defined pocket.

To move the shades 20, 22 between extended and retracted positions, an operator may independently manipulate the operating elements 30, 32 (see FIGS. 1A-1C) to wrap or unwrap the shades 20, 22 about or from the rollers 38, 40. For example, to move the front shade 20 from the open, extended configuration of FIG. 1A into the retracted position of FIG. 1C, the operator may move the operating element 30 in a circulating motion to actuate a drive system, such as a pulley wheel coupled to a gear reduction unit. The drive system may rotate the roller 38 in a retraction direction, which in turn may wrap the shade 20 about a periphery of the roller 38, thereby retracting the first shade 20 into the head rail 14 (see FIGS. 2A-2C). Similarly, to move the second shade 22 from the extended position of FIG. 1A to the retracted position of FIG. 1C, the operator may move the operating element 32 in a circulating motion to actuate a drive system, such as a pulley wheel coupled to a gear reduction unit. The drive system may rotate the roller 40 in a retraction direction, which in turn may wrap the shade 22 about a periphery of the roller 40, thereby retracting the second shade 22 into the head rail 14 (see FIGS. 2A-2C). Conversely, to extend the shades 20, 22 across the architectural opening, the operator may move the operating elements 30, 32 in a reverse circulating motion to unwrap the shades 20, 22 from the rollers 38, 40.

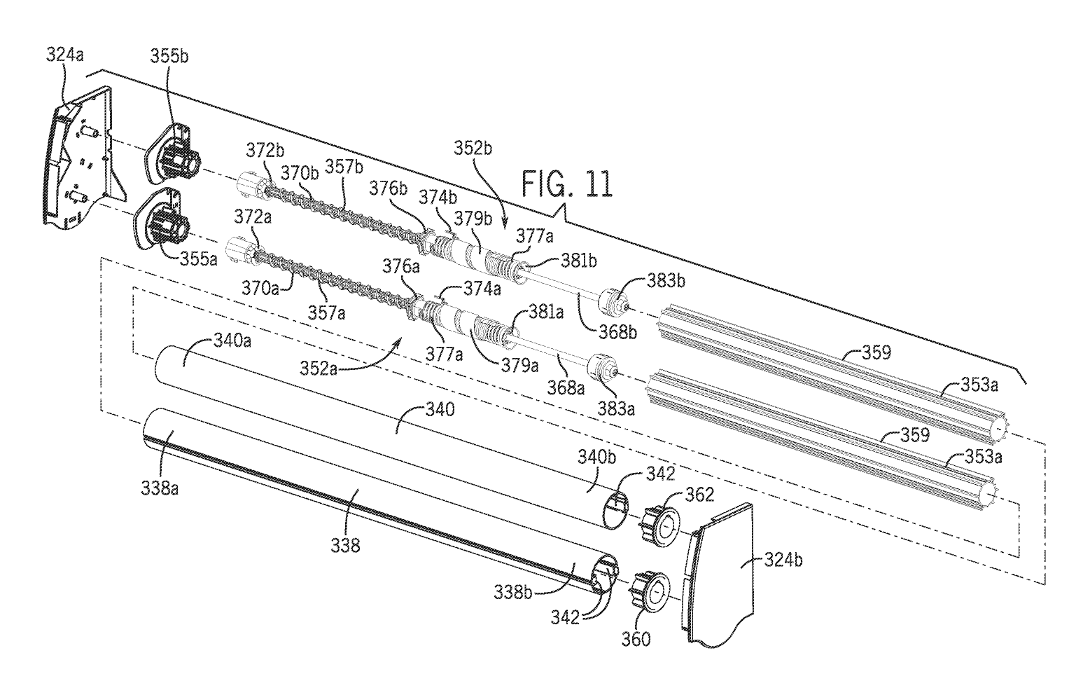

The covering 10 may be operated mechanically and/or electrically. For example, one or both of the operating elements 30, 32 (and an associated pulley wheel) may be replaced with an electric motor configured to extend or retract the shades 20, 22 upon receiving an extension or retraction command. Additionally or alternatively, one or both of the operating elements 30, 32 (and an associated pulley wheel) may be replaced with a spring assist module (see FIG. 11). In other words, the operating system may include a pulley assembly (actuated by an operating element, for example), an electric motor, a spring-assist module, a combination thereof, or any other suitable drive element or mechanism. If the operating system includes an electric motor, the covering 10 may include a transceiver operable to communicate with a transmitter, such as a remote control unit.

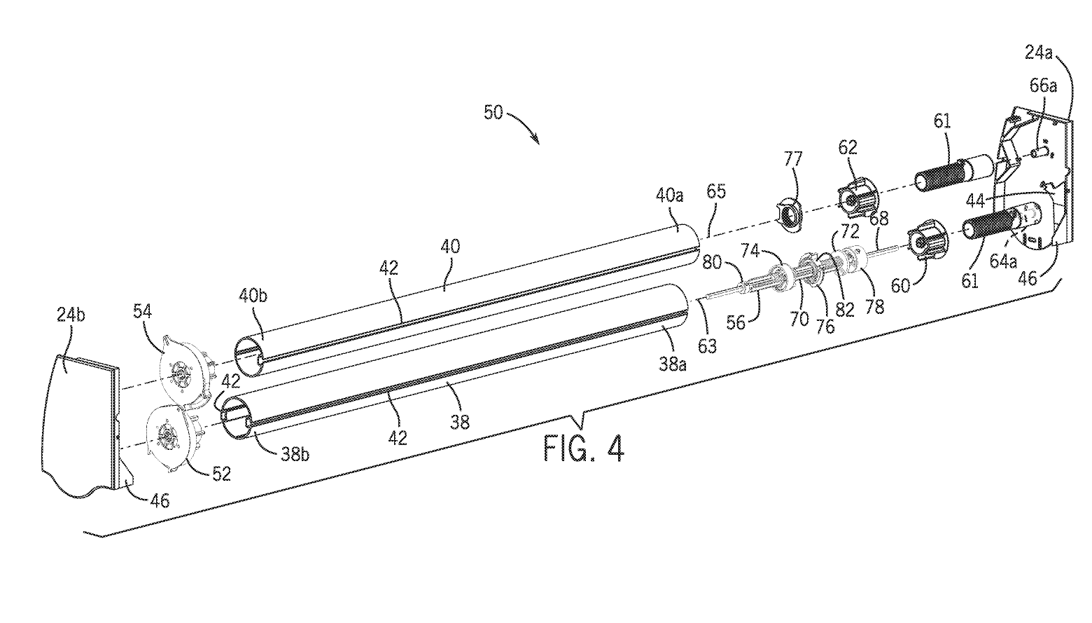

With reference to FIGS. 3-4, a partially exploded, isometric view of a head rail assembly 50 is provided. The head rail assembly 50 may include the first and second end caps 24a, 24b, first and second rollers 38, 40, first and second operating systems 52, 54, first and second limit assemblies 56, 58, and first and second bushings 60, 62. The first or front shade 20 may be associated with both end caps 24a, 24b, the first roller 38, the first operating system 52, the first limit assembly 56, and the first bushing 60. The second or rear shade 22 may be associated with both end caps 24a, 24b, the second roller 40, the second operating system 54, the second limit assembly 58, and the second bushing 62. The respective end caps 24a, 24b, rollers 38, 40, operating systems 52, 54, and bushings 60, 62 may be substantially identical to one another.

The rollers 38, 40 may be rotatable relative to one another and to the end caps 24a, 24b about separate longitudinal axes 63, 65. The longitudinal axes 63, 65 may be substantially parallel to, but laterally offset from, one another. The rollers 38, 40 may be operably associated with the operating systems 52, 54 and the bushings 60, 62. The operating systems 52, 54 may independently drive or rotate the rollers 38, 40 about the respective longitudinal axes 63, 65 while the bushings 60, 62 may support the rollers 38, 40 in opposing relationship to the operating systems 52, 54. Although the operating systems 52, 54 are illustrated as being associated with common ends 38b, 40b of the rollers 38, 40, the operating systems 52, 54 may be associated with different ends of the rollers 38, 40. Similarly, although the bushings 60, 62 are illustrated as being associated with common ends 38a, 40a of the rollers 38, 40, the bushings 60, 62 may be associated with different ends of the rollers 38, 40.

With continued reference to FIGS. 3-4, the bushings 60, 62 may be configured to support an end 38a, 40a of the rollers 38, 40, respectively. The bushings 60, 62 may be mounted onto and rotatably bear against respective stub shafts 61, which may be mounted onto non-rotatable posts 64a, 66a of the end cap 42 and may protrude axially from the end cap 24a. The bushings 60, 62 may be keyed to the rollers 38, 40 to rotate in unison with the rollers 38, 40 relative to the stub shafts 61. For example, the bushings 60, 62 may extend at least partially into an interior space of the ends 38a, 40a of the rollers 38, 40. The bushings 60, 62 may include a plurality of circumferentially-spaced, radially-extending ribs configured to engage an inner surface of the rollers 38, 40 and/or interact with a longitudinally-extending gland 42 formed in the rollers 38, 40.

With continued reference to FIGS. 3-4, the operating systems 52, 54 may be configured to support an opposing end 38b, 40b of the rollers 38, 40 relative to the bushings 60, 62. The operating systems 52, 54 may be rotatably associated with non-rotatable posts 64b, 66b that protrude axially from the end cap 24b. The operating systems 52, 54 may be configured to drive or rotate the rollers uni-directionally or bi-directionally to wrap or unwrap the shades 20, 22 around or from the rollers 38, 40. The operating systems 52, 54 may include a brake and/or clutch member (such as one or more wrap springs), a gear reduction member (such as a planetary gear set), and/or other suitable operating system members. The operating systems 52, 54 may be actuated by the operating elements 30, 32 (FIGS. 1A-1C) or other suitable elements. The operating systems 52, 54 may extend at least partially into an interior space of the ends 38b, 40b of the rollers 38, 40 and may include a plurality of circumferentially-spaced, radially-extending ribs configured to engage an inner surface of the rollers 38, 40 and/or interact with a longitudinally-extending gland 42.

With continued reference to FIGS. 3-4, the head rail assembly 50 may include a limit assembly configured to set a travel limit or stop for the shades 20, 22. The head rail assembly 50 may include first and second limit assemblies 56, 58 for the rollers 38, 40. The first and second limit assemblies 56, 58 may be positioned within an interior space defined by the rollers 38, 40 by inserting the assemblies 56, 58 through an opening defined by an end 38a, 40a of a roller 38, 40. The first roller 38 and the first limit assembly 56 may be substantially aligned along the first longitudinal axis 63, and the second roller 40 and the second limit assembly 58 may be aligned along the second longitudinal axis 65. The first and second limit assemblies 56, 58 may be substantially identical to, or different from, one another.

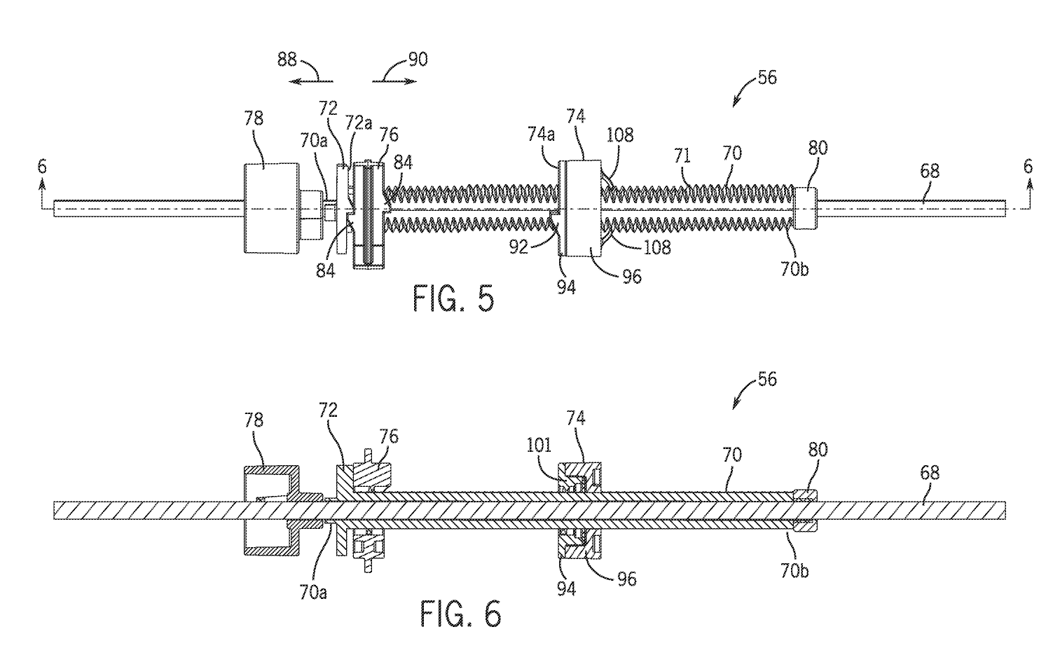

With reference to FIGS. 5-7, the first limit assembly 56 may include dual travel limit stops, and thus may be referred to as a dual limit assembly. The first limit assembly 56 may be assembled as a single, modular unit. The first limit assembly 56 may be added to existing coverings (L e., retrofit) and may be referred to as a module, system, or unit.

As shown in FIGS. 3-7, the first limit assembly 56 may include a non-rotatable central axle 68, an externally-threaded shaft or limit screw 70, a bottom travel limit or end stop 72, a top travel limit or end stop 74, and a travelable nut 76. The axle 68 may be non-rotatably attached to the end cap 24a and may extend through a central bore of the dual limit assembly 56. The axle 68 may include a longitudinally-extending groove, rib, or other keying structure.

The externally-threaded limit screw 70 may be mounted onto the axle 68 and may be substantially non-slidable or longitudinally restrained relative to the axle 68. For example, opposing axle collars 78, 80 may be mounted onto the axle 68 in confronting relationship with opposite ends 70a, 70b of the limit screw 70 (see FIGS. 5-7). The axle collars 78, 80 may be non-slidably secured to the axle 68 by fasteners, such as set screws, to axially restrain the externally-threaded limit screw 70 relative to the central axle 68. Alternatively, opposing push nuts or other suitable fasteners may be secured to the axle 68 to restrain longitudinal motion of the limit screw 70 relative to the axle 68. The axle collars 78 may thread onto an end of the stub shafts 61 to secure the limit assemblies 56, 58 to the end cap 24a.

Additionally or alternatively, the externally-threaded limit screw 70 may be substantially non-rotatable or rotationally restrained relative to the axle 68. For example, the axle collars 78, 80 may be non-rotatably secured to the axle 68 by fasteners, such as set screws. The axle collars 78, 80 may be non-rotatably keyed or otherwise secured to opposing ends of the limit screw 70 to rotationally restrain the limit screw 70 relative to the axle 68. As another example, the limit screw 70 may be non-rotatably keyed directly to the shaft.

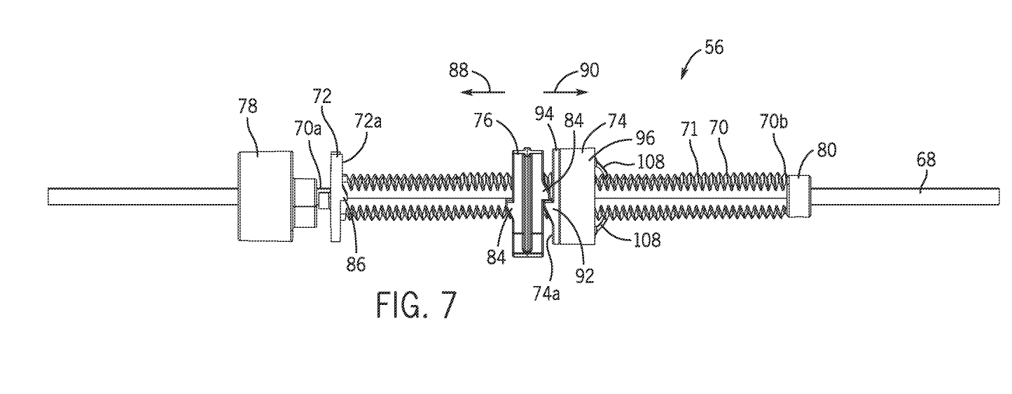

With reference to FIGS. 3-9, the travelable nut 76 may be threadably mounted onto the threaded section 66b of the shaft 66 and may be non-rotatably keyed to the roller 38 to rotate in unison with the roller 38. The nut 76 may define a slot 82 opening through a periphery of the nut 76 and configured to receive the longitudinally-extending gland 42 of the roller 42. During rotation of the roller 38 in a shade dispensing or extending direction, the nut 76 may translate axially along the external thread 71 of the limit screw 70 away from the top stop 74 toward the bottom stop 72 (represented by arrow 88 in FIGS. 5 and 7). Conversely, during rotation of the roller 38 in a shade raising or retracting direction, the nut 76 may translate axially along the limit screw 70 away from bottom stop 72 toward the top stop 74 (represented by arrow 90 in FIGS. 5 and 7).

With reference to FIGS. 5 and 7-9, the nut 76 may include a pair of lugs 84 projecting from opposing faces 76a, 76b of the nut 76 in generally opposing directions. The lugs 84 may be substantially identical to one another. When the shade 20 is in a fully-extended position (see FIGS. 1A and 2A), one of the lugs 84 may contact a corresponding tab 86 projecting from a confronting face 72a of the bottom stop 72 to substantially prevent further translation of the nut 76 in the extension direction 88 (see FIGS. 5 and 7), thereby substantially preventing further extension of the shade 20 since the nut 76 is non-rotatably keyed to the roller 38. In other words, the bottom stop 72 may set an extension limit of the shade 20 by substantially preventing translation of the nut 76 beyond the bottom stop 72.

From the fully-extended position, the shade 20 may be retracted by rotating the roller 38 in a shade retraction direction, which in turn may translate the nut 76 along the threaded limit screw 70 away from the bottom stop 72 toward the top stop 74 in the retraction direction 90 (see FIGS. 5 and 7). When the shade 20 reaches a fully-retracted position (see FIGS. 1C and 2C), the other of the lugs 84 may contact a corresponding tab 92 projecting from a confronting face 74a of the top stop 74 to substantially prevent further translation of the nut 76 in the retraction direction 90, thereby substantially preventing further retraction of the shade 20. In other words, the top stop 74 may set a retraction limit of the shade 20. In this manner, the dual limit assembly 56 may set an extension limit of the shade 20 (with the bottom stop 72) and a retraction limit of the shade 20 (with the top stop 74).

To accommodate various sizes of architectural openings, the top stop 74 may be adjustable or translatable longitudinally along the threaded limit screw 70 relative to the bottom stop 72. The adjustability of the top stop 74 may allow an installer or operator to alter the effective length of the shade 20 by selectively setting a longitudinal distance between the bottom stop 72 and the top stop 74 based on the dimensions of an associated architectural opening. That is, the top stop 74 may be moved along the threaded limit screw 70 so that the longitudinal distance between the bottom stop 72 and the top stop 74 generally corresponds with a height or length of an associated architectural opening. After being moved into a desired position, the top stop 74 may be fixedly secured to the limit screw 70.

With reference to FIGS. 5-9, the bottom stop 72 may be substantially immovable or stationary relative to the limit screw 70. The bottom stop 72 may be formed integrally with, or separately from and fixedly attached to, the limit screw 70. The bottom stop 72 may extend outward from a periphery of the threaded limit screw 70 and may form an outwardly-extending abutment flange. As previously discussed, a tab 86 may protrude from a face 72a of the bottom stop 72. The tab 86 may be radially positioned within a rotational path of the lug 84 of the travelable nut 76. Thus, the tab 86 may contact the lug 84 during rotation of the nut 76 in the extension direction 88 (see FIGS. 5 and 7) to substantially prevent further rotation, and thus translation, of the nut 76 relative to the limit screw 70 in the extension direction 88.

With continued reference to FIGS. 5-9, the top stop 74 may be longitudinally adjustable or movable along the threaded limit screw 70 relative to the bottom stop 72. The top stop 74 may include a first member 94 and a second member 96. The first and second members 94, 96 may be independently movable along the threaded limit screw 70.

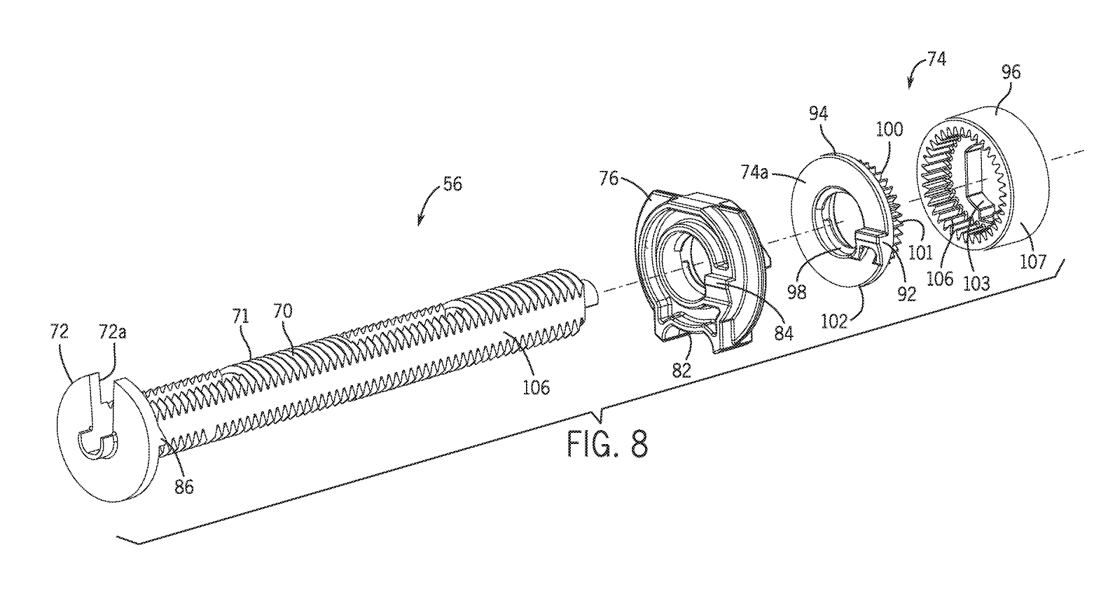

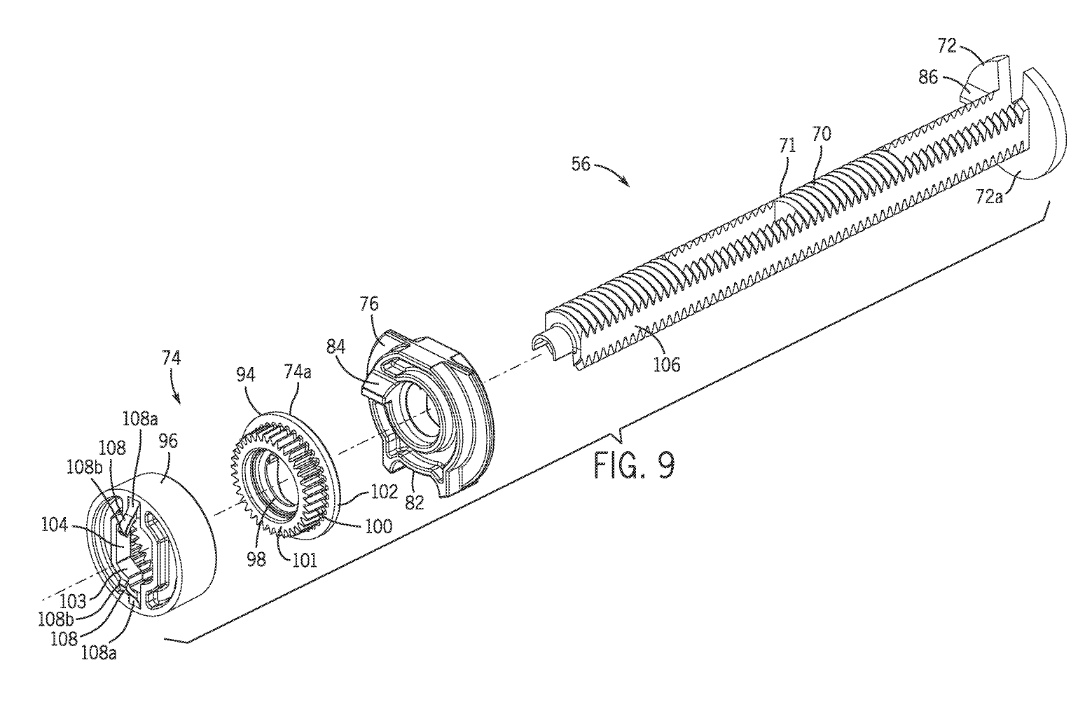

The first member 94 may be rotatable, but substantially non-slidable, relative to the threaded limit screw 70. The first member 94 may be referred to as a limit adjustment member. With reference to FIGS. 8-9, the first member 94 may be internally threaded. That is, the first member 94 may include an internal thread 98 configured to threadably engage the externally-threaded limit screw 70. By rotating the first member 94 about the limit screw 70, the first member 94 may travel axially along the limit screw 70. The engagement of the internal thread 98 and the external thread 71 of the limit screw 70 may substantially prevent the first member 94 from sliding relative to the limit screw 70.

With continued reference to FIGS. 8-9, the first member 94 may be externally toothed and may be referred to as an external or male spline. That is, the first member 94 may include a plurality of longitudinally-extending, peripherally-spaced splines or teeth 100. The first member 94 may include a plurality of longitudinally-extending, circumferentially-spaced splines or teeth 100 protruding radially outward from a boss 101. A circumferential flange 102 may extend radially outward from the boss 101 beyond the teeth 100. When threaded onto the limit screw 70, the circumferential flange 102 may be located longitudinally between the bottom stop 72 and the teeth 100.

The second member 96 may be slidable, but substantially non-rotatable, relative to the threaded limit screw 70. The second member 96 may be reference to as a limit lock member. With reference to FIGS. 8-9, the second member 96 may be non-rotatably, but slidably, keyed to the externally-threaded limit screw 70. For example, the second member 96 may include an internal wall 103 having opposing, substantially flat side walls 104 that generally correspond in orientation to longitudinally-extending flats 106 formed in opposing sides of the externally-threaded limit screw 70. The remaining portion of the internal wall 103 of the second member 96 may be oversized relative to a major diameter of the external thread 71 of the limit screw 70. Thus, when the second member 96 is slid onto the limit screw 70, the side walls 104 of the second member 96 may be substantially congruent with the flats 106 of the limit screw 70 to substantially prevent rotation of the second member 96 relative to the limit screw 70 while permitting axial movement of the second member 96 along the externally-threaded limit screw 70.

With continued reference to FIGS. 8-9, the second member 96 may be internally toothed and may be referred to as an internal or female spline. That is, the second member 96 may include a plurality of longitudinally-extending, peripherally-spaced splines or teeth 106. The second member 96 may include a plurality of longitudinally-extending, circumferentially-spaced splines or teeth 106 protruding radially inward from a substantially cylindrical inner surface of the second member 96. The internal teeth 106 of the second member 96 may be configured to meshingly engage the external teeth 100 of the first member 94. The longitudinal length of the external and internal teeth 100, 106 may be varied to provide sufficient engagement of the teeth 100, 106 upon rotational alignment and translatable engagement of the first and second members 94, 96 to substantially prevent rotation of the top stop 74. In some implementations, the combined longitudinal length of the teeth 100, 106 is greater than one-half the pitch of the external thread 71 of the limit screw 70 (i.e., one-half the longitudinal distance between consecutive crests of the thread). In some implementations, the combined longitudinal length of the teeth 100, 106 is greater than the distance between successive crests of the external thread 71 of the limit screw 70. In some implementations, the length of the teeth 100, 106 of the first and second members 94, 96 are substantially equal to one another. The second member 96 may include a substantially cylindrical outer surface 107.

With reference to FIGS. 5, 7, and 9, the second member 96 may include one or more cantilevered, substantially resilient ratchet arms or fingers 108. Each arm 108 may include a connected end 108a and a free end 108b extending radially inward from the connected end 108a toward the externally-threaded limit screw 70. The free ends 108b of the resilient arms 108 may be directed toward one another in opposing relationship and may be separated from each other by a distance that is generally less than a major diameter of the external thread 71 of the limit screw 70 so that the free ends 108b extend into a channel or groove formed between successive crests or peaks of the external thread 71. In operation, the free ends 108b of the ratchet fingers 108 may contact successive edges of the external thread 71 and may resiliently deform to permit continuous axial or longitudinal translation of the second member 96 relative to the limit screw 70 in one direction. Conversely, the free ends 108b of the ratchet fingers 108 may catch or engage the edges of the external thread 71 in an opposite longitudinal direction, thereby substantially preventing motion of the second member 96 in the opposite direction relative to the limit screw 70. Thus, the resilient ratchet arms 108 may provide a unidirectional lock allowing the second member 96 to be axially moved along the limit screw 70 in one direction but substantially preventing axial movement of the second member 96 in the opposite direction. The free ends 108b of the resilient arms 108 may extend longitudinally away from the connected ends 108a of the resilient arms 108. The resilient arms 108 may protrude from an opposite end of the top stop 74 relative to the confronting face 74a of the top stop 74.

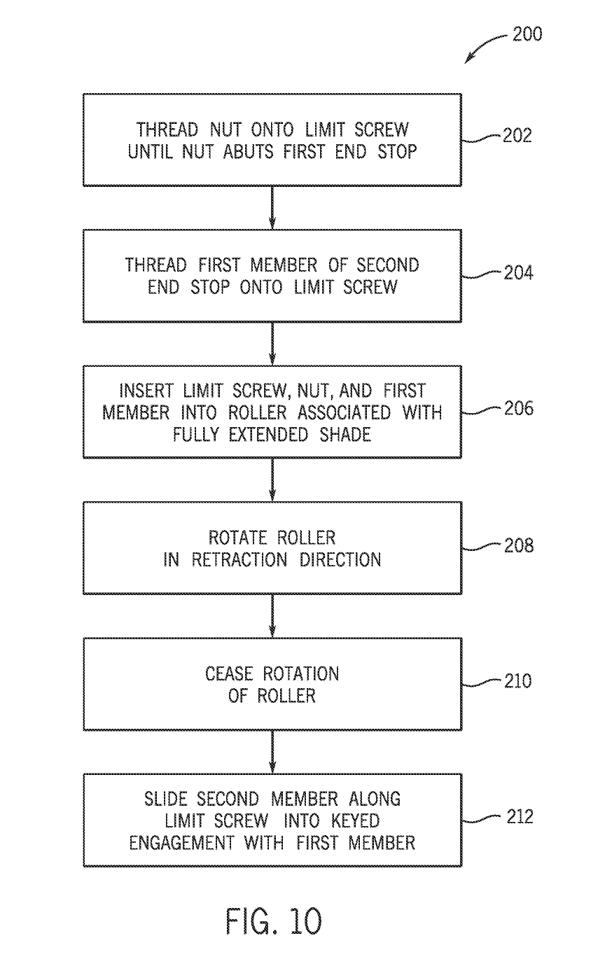

With reference to FIG. 10, a method 200 of setting a retraction limit or top stop for a covering for an architectural opening is provided. The method 200 may include threading a nut 76 onto a limit screw 70 associated with a covering 10 for an architectural opening until the nut 76 abuts a first stop 72 (operation 202). The method 200 may include threading a first member 94 of a second stop 74 onto the limit screw 70 until the first member 94 abuts an opposing side of the nut 76 relative to the first stop 72 (operation 204). The method 200 may include inserting the limit screw 70, the nut 76, and the first member 94 into an inner space of a roller 38 associated with a fully extended shade 20 (operation 206).

The method 200 may include rotating the roller 38 in a retraction direction (operation 208). Rotation of the roller 38 in the retraction direction may rotate the nut 76 about the limit screw 70, thereby translating the nut 76 along the limit screw 70 away from the first stop 72. During the translation of the nut 76 along the limit screw 70, the nut 76 may rotate the first member 94 of the second stop 74 about the limit screw 70 via the interface of the lug 84 of the nut 76 and the tab 92 of the first member 94 of the second stop 74, thereby translating the first member 94 of the second stop 74 along the limit screw 70 substantially in unison with the nut 76. Rotation of the roller 38 may continue until the shade 20 is retracted a desired amount or length based on the dimensions of the architectural opening, for example.

Once the shade 20 is retracted the desired amount, rotation of the roller 38 may be ceased (operation 210). As the nut 76 may remain in contact with and rotate the first member 94 of the second stop 74 during the retraction of the shade 20, the first member 94 may be in a desired retraction limit position relative to the first end stop 72 upon cessation of rotation of the roller 38. The method 200 may include sliding a second member 96 of the second stop 74 along the limit screw 70 into keyed engagement with the first member 94 of the second stop 74 (operation 212). The keyed engagement may include intermeshed splines, teeth, or other suitable keying structures. For example, the first member 94 of the second stop 74 may include outwardly-extending teeth configured to matingly engage with inwardly-extending teeth of the second member 96 of the second stop 74. As such, the second member 96 may be moved axially along the limit screw 70 relative to the first member 94 to engage the respective keying structures of the first and second members 94, 96 of the second stop 74.

The second member 96 may include resilient arms or tangs 108 that permit sliding of the second member 96 in a direction toward the first member 94 along the limit screw 70 but that substantially restrain sliding of the second member 96 in an opposite direction away from the first member 94. Once the respective teeth engage one another, the first member 94 of the second stop 74 may substantially prevent the second member 96 of the second stop 74 from sliding in a direction toward the first stop 72 since the first member 94 may be non-slidable relative to the limit screw 70. Additionally, the arms 108 of the second member 96 may substantially prevent the second member 96 of the second stop 74 from sliding in a direction axially away from the first stop 72 and the first member 94 of the second stop 74. Thus, the second member 96 may be slidably locked relative to the limit screw 70 by the first member 94 and the resilient arms 108. As the second member 96 of the second stop 74 may be non-rotatably keyed to the limit screw 70, the second member 96 may substantially prevent the first member 94 from rotating about the limit screw 70. Thus, the first member 94 may be non-rotatably locked relative to the limit screw 70 by the second member 96. In this manner, once engaged, the first and second members 94, 96 may be substantially fixed or locked in position relative to the first stop 72, thereby setting the second stop 74 relative to the limit screw 70 and the first stop 72. To readjust the position of the second stop 74, a tool or implement may be used to resiliently deform the arms 108 of the second member 96 of the second stop 74, thereby permitting the second member 96 to be slid relative to and disengaged from the first member 94 of the second stop 74.

With reference back to FIGS. 5-7, the top stop 74 is illustrated in a locked configuration in which the first and second members 94, 96 are engaged with one another. In particular, the external teeth 100 of the first member 94 may be intermeshed with the internal teeth 106 of the second member 96. As illustrated in FIG. 6, a face of the second member 96 may abut or contact the circumferential flange 102 of the first member 94 to substantially prevent further insertion of the second member 96 about the first member 94.

The keyed engagement of the first and second members 94, 96 of the second or top stop 74 may be advantageous relative to conventional top stops. For example, the first and second members 94, 96 may provide more accurate positioning of the stop. Conventional end stops may include a resolution of one-thread increments along the limit screw 70. The one-thread increment generally equates to one revolution of the roller 38, which may result in a resolution substantially equal to the diameter of the roller, which may be about three to four inches. In contrast, the provided stop 74 may have an increment or resolution of less than one revolution of the roller. For example, the provided stop 74 may have an increment or resolution substantially equal to one revolution of the roller 38 divided by the number of teeth 100, 106 on the first or second members 94, 96. The number of teeth 100, 106 on the first and second members 94, 96 may be altered based on the desired resolution of the positioning of the top stop 74. For example, the number of teeth 100, 106 may be between about 2 teeth and about 360 teeth or more. In one implementation, the number of teeth 100, 106 included on each of the first and second members 94, 96 of the top stop 74 is about 36 teeth.

With reference back to FIGS. 3-4, the second limit assembly 58 may include a single travel limit or stop, and thus may be referred to as a single or unitary limit assembly. The second limit assembly 58 may include a travelable nut 77 threaded onto an externally-threaded portion of the stub shaft 61. The travelable nut 77 may be substantially identical to the travelable nut 76, with the exception that the nut 77 may include only one lug (as the second limit assembly 58 may include only a single limit), which may be configured to interact with the bottom stop 72 formed on the stub shaft 61. The second limit assembly 58 may operate substantially the same way as the first limit assembly 56 (with the exception of the top stop 74), and thus the second limit assembly 58 is not further discussed herein for brevity purposes. Alternatively, the second limit assembly 58 may include the same parts as the dual limit assembly 56, with the exception of the top stop 74. That is, the second limit assembly 58 may include a non-rotatable central axle 68, an externally threaded shaft or limit screw 70, a bottom stop 72, a travelable nut 76, and axle collars 78, 80. As should be understood, the second limit assembly 58 may include a top stop 74, similar to the first limit assembly 56. Incorporating the top stop 74 into the second limit assembly 58 may convert the second limit assembly 58 into a dual limit assembly 56, with the same general function as that previously described in relation to the first shade 20. One or both of the rollers 38, 40 may be associated with the dual limit assembly 56 or the single limit assembly 58.

In some implementations, instead of employing a top stop 74 in connection with the second or rear shade 22, the bottom rail 18 of the second shade 22 may interact with a portion of the end cap 24b to substantially prevent further retraction of the second shade 22. That is, the interaction between the bottom rail 18 and the end cap 24b may function as a top stop to provide a retraction limit for the second shade 22. For example, the bottom rail 18 may include an ear 19 protruding longitudinally from an end of the bottom rail 18. The ear 19 may contact a portion of the end cap 24b to provide the second shade 22 with an upper travel limit or stop. With reference to FIG. 2C, in a fully retracted position, the ear 19 of the bottom rail 18 of the second shade 22 may contact or interact with one or both end caps 24a, 24b to substantially prevent further retraction of the second shade 22. In one implementation, the ear 19 interacts with a cord guide 44 associated with an end cap 24a, 24b that defines a passage for routing the operating element 32 associated with the second shade 22. The ear 19 may contact a portion of the cord guide 44 without interfering with the operating element 32. As such, the ear 19 of the bottom rail 18 and the cord guide 44 may act as a retraction stop, top stop, or upper limit of the second shade 22.

To ensure the ear 19 of the bottom rail 18 substantially aligns with the cord guide 44 during retraction of the shade 22, either or both end caps 24a, 24b may include a wing 46, which may substantially prevent the bottom rail 18 from rearwardly misaligning with a lower portion 48 of the cord guide 44. The wing 46 may extend longitudinally from a respective end cap 26a, 26b toward an opposing respective end cap 26b, 26a beyond an edge portion of the second shade 22. The wing 46 may be positioned rearward of the cord guide 44 and the second shade 22. As such, the wing 46 may impede or obstruct a rearward motion (such as a swinging motion) of the second shade 22. The wing 46 may be formed as a substantially flat plate and may be oriented substantially parallel to an extended portion of the second shade 22.

FIGS. 11-17 illustrate a second implementation of a head rail assembly 350 that may be used with the covering 10 illustrated in FIGS. 1A-1C. The head rail assembly 350 is similar to the head rail assembly 50 illustrated in FIGS. 3-4, except that the head rail assembly 350 includes a different operating system 352a, 352b, relative to the head rail assembly 50. With the exception of these differences, the head rail assembly 350 generally has the same features and operation as the head rail assembly 50. Accordingly, the preceding discussion of the features and operation of the head rail assembly 50 should be considered equally applicable to the head rail assembly 350, except as noted in the following discussion. The reference numerals used in FIGS. 11-17 generally correspond to the reference numbers used in FIGS. 1-10 to reflect the similar parts and components, except the reference numerals are incremented by two hundred.

With reference to FIGS. 11 and 14-16, the head rail assembly 350 may include a set of end caps 324a, 324b, rollers 338, 340, operating systems 352a, 352b, first end bushings 355a, 355b, and second end bushings 360, 362. The set of operating systems 352a, 352b may be substantially identical to one another. Thus, only one of the operating systems 352a, 352b will be discussed for brevity purposes.

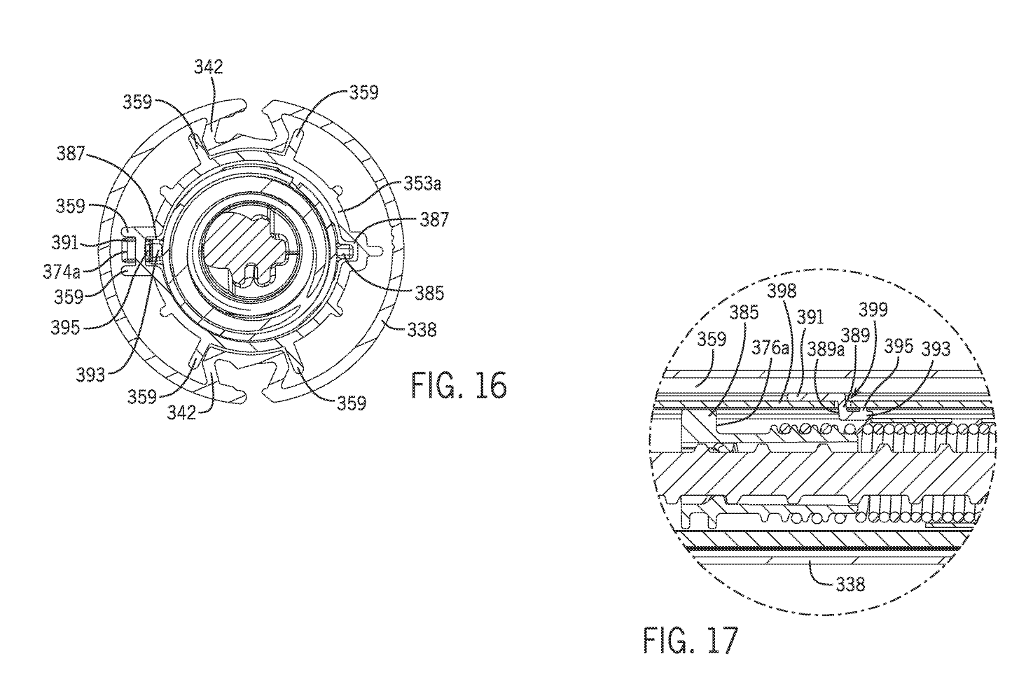

The operating system 352a may include an elongate tube 353a and a counterbalancing unit 357a. The tube 353a (which may be referred to as an inner tube) may be insertable within and non-rotatably keyed to the roller 338 (which may be referred to as an outer tube). The tube 353a may include a plurality of longitudinally-extending, circumferentially-spaced ribs 359 radiating outward from a periphery of the tube 353a. The ribs 359 may interact with a longitudinally-extending, inwardly directed gland 342 of the roller 338 (see FIG. 16) so that the inner tube 353a and the roller 338 may rotate substantially in unison with one another.

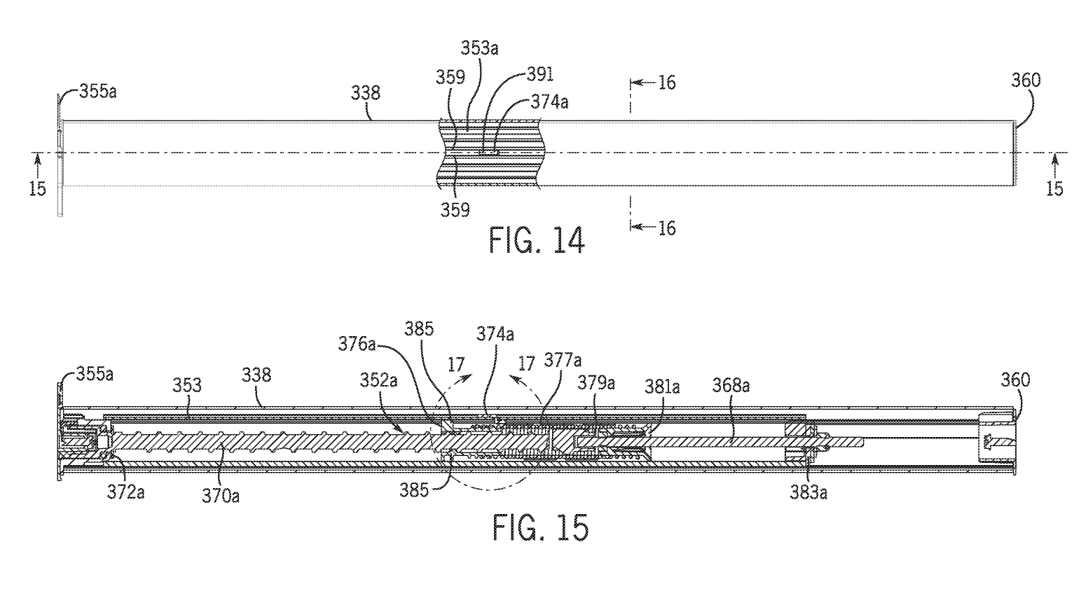

The counterbalancing unit 357a may be insertable within and non-rotatably keyed to the inner tube 353a. The counterbalancing unit 357a may include a central axle 368a, an externally-threaded limit screw or shaft 370a non-rotatably mounted onto the axle 368a, a bottom stop or limit 372a mounted onto the axle 368a, a top stop or limit 374a, a translatable nut 376a threadably mounted onto the limit screw 370a, an immovable anchor 381a fixed to the axle 368a, a biasing element interconnecting the translatable nut 376a and the fixed end anchor 381a, and an end plug 383a associated with an end of the axle 368a. The bottom stop 373a may be a c-clip (see FIGS. 11 and 15) or any other component that provides an abutment surface for the translatable nut 376a. The top stop 374a is separated from the inner tube 353a in FIG. 11 for clarity purposes. When the operating system 352 is assembled (FIGS. 14-17), the top stop 374a may be removably attached to the inner tube 353a and similarly positioned relative to the counterbalancing unit 357a as that shown in FIG. 11. The biasing element may be a coil spring 377a, an outer spiral wrap element 379a, both, or any other suitable biasing element.

With reference to FIG. 15, the counterbalancing unit 357a is positioned within the inner tube 363a, which in turn is positioned within the roller 338a. The bushing 355a may support one end of the counterbalancing unit 357a, may substantially abut one end of the inner tube 363a, and may be inserted partially into a corresponding end of the roller 338a. The end plug 383a may be inserted at least partially into an opposing end of the inner tube 363a and may support the associated end of the counterbalancing unit 357a substantially concentrically within the inner tube 353a. The bushing 360 may support an opposing end of the roller 338a proximate to the end plug 383a. Further details regarding the structure and operation of the counterbalancing unit 357a, 357b may be found in International Publication No. WO 2013/033014 A1, which is hereby incorporated by reference herein in its entirety.

With reference to FIGS. 15-17, the translatable nut 376a may be non-rotatably keyed to the inner tube 353a and may rotate substantially in unison with the inner tube 353a. The nut 376a may include longitudinally-extending fins 385 that protrude radially outward from an outer periphery of the nut 376a. The fins 385 may reside within longitudinally-extending channels 387 that open through an inner periphery of the tube 353a into an inner space of the tube 353a. During movement of the shade 20, the fins 285 may travel within the channels 387 in a longitudinal direction. During operation of the shade 20, the top stop 374a may extend at least partially into the channel 387, thereby obstructing the longitudinal path of the fins 285 and substantially preventing passage of the fin 285 (and thus the nut 376a) axially beyond the top stop 374a.

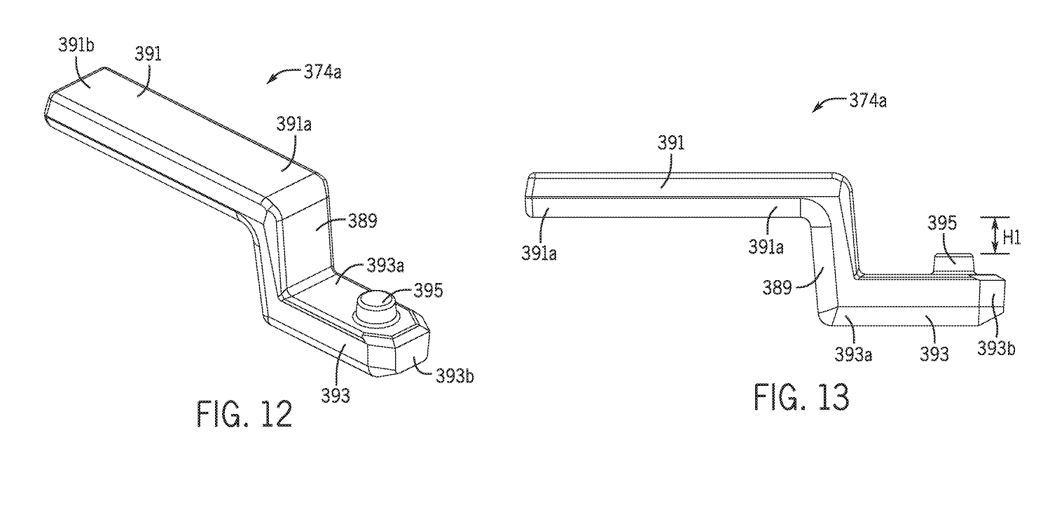

With reference to FIGS. 12-13, the top stop or stop element 374a may include a riser 389 and a pair of legs 391, 393 extending from opposite ends of the riser 389 in generally opposite directions relative to one another. The first and second legs 391, 393 may be substantially parallel to one another. The first and second legs 391, 393 may be oriented substantially perpendicular to the riser 389. The first and second legs 391, 393 each may include a first end 391a, 393a attached to the riser 389 and a free end or tip 391b, 393b. The free end 393b of the second leg 393 may be arcuate, rounded, or distally tapered to facilitate insertion through the side wall of the inner tube 353a and/or positioning of the tip 393b within the inner tube 353a. The legs 391, 393 may be referred to as first and second portions 391, 393 of the stop element 374a, and the riser 389 may be referred to as an intermediate portion 389 of the stop element 374a.

With continued reference to FIGS. 12-13, the second leg 393 of the top stop 374a may include a knob 395 protruding away from the second leg 393 in the same general direction as the riser 389. The knob 395 may be axially spaced from the riser 395. The riser 389 may have an effective height H1, which may be the distance between an inward face of the first leg 391 and an outer face of the knob 395. The height H1 may generally correspond to a wall thickness of the inner tube 353a. In some implementations, the second leg 393 does not include the knob 395. In these implementations, the length of the riser may be substantially equal to the wall thickness of the inner tube 353a. The legs 391, 393 and the riser 389 may be integrally formed as a single unit or formed separately and attached to one another.

With reference to FIGS. 14-17, the first or outer leg 391 of the top stop 374a may be positioned circumferentially between opposing ribs 359 in abutting relationship with an outer surface of the inner tube 353a. The width of the first leg 391 may be substantially the same as the distance between the opposing ribs 359 to substantially prevent the top stop 374a from rotating about a yaw axis, which may extend substantially vertically through the riser 389. The first leg 391 may extend longitudinally along the outer surface of inner tube 353a.

With continued reference to FIGS. 15-17, the second or inner leg 393 of the top stop 374a may be positioned inside the inner tube 353a within a channel 387 that accommodates a fin 385 of the translatable nut 376. The channel 387 may be defined by opposing ribs 359 of the inner tube 353a. The second leg 393 may be positioned circumferentially between the opposing ribs 359. The width of the second leg 393 may be substantially the same as the distance between the opposing ribs 359. The knob 395 of the second leg 393 may abut or confront an inner surface or wall of the inner tube 353a. In implementations where the knob 395 is not included on the second leg 393, the second leg 393 may abut the inner surface or wall of the inner tube 353a. The second leg 393 may extend longitudinally along the inner surface of the inner tube 353a.

With reference to FIGS. 15 and 17, the riser 389 of the top stop 374a may extend through an aperture 399 formed through a wall 398 of the inner tube 353a. The aperture 399 may be slightly oversized to permit the second leg 393, including the knob 395, to pass through the aperture 399. The riser 389 may be oriented substantially perpendicular to the inner tube 353a.

With reference to FIGS. 11, 15, and 17, when the head rail assembly 350 is assembled, rotation of the roller 338 in an extension direction may rotate the inner tube 353a in the extension direction, which in turn may rotate the travelable nut 376a about the limit screw 370. The rotation of the travelable nut 376a relative to the limit screw 370 may cause the nut 376a to translate along the limit screw 370a away from the top stop 374a toward the bottom stop 372a. During this translation of the nut 376a along the limit screw 370a, the coil spring 377a and the spiral wrap element 379a may provide a counterbalancing force that may be substantially equal to the weight of the suspended portion of the shade 20 (see International Publication No. WO 2013/033014 A1). As such, once the extending force is ceased, the counterbalancing unit 357a may substantially hold or maintain the shade 20 in the respective extended position. Upon the nut 376a reaching the bottom stop 372a, the stop 372a may substantially prevent further rotation of the nut 376a in the extension direction, thereby substantially preventing further extension of the shade 20.

With continued reference to FIGS. 11, 15, and 17, rotation of the roller 338 in a retraction direction may rotate the inner tube 353a in the same direction, which in turn may rotate the travelable nut 376a about the limit screw 370. The rotation of the travelable nut 376a may cause the nut 376a to translate along the limit screw 370a away from the bottom stop 372a toward the top stop 374a. Upon the nut 376a reaching the top stop 374a, the stop 374a may substantially prevent further translation of the nut 376a in the retraction direction, thereby substantially preventing further retraction of the shade 20. In one implementation, the fin 375 of the nut 376a may contact or engage the riser 389 (for example an abutment surface 389a) to substantially prevent further retraction of the shade 20. Upon the nut 376a contacting or engaging the riser 389, the knob 395 may substantially prevent the top stop 374a from rotating or pivoting about a pitch axis, which may extend substantially horizontally through the riser 389 in a cross-wise direction.

The top stop 374a may have many advantages. For example, the top stop 374a may provide an internal stop that is externally settable and removable relative to a tube. As such, an existing operating system may be modified or retrofit to include a positive travel limit or stop without requiring disassembly of the operating system, which may include a counterbalancing unit. Further, if the top stop 374a is no longer desired, the stop 374a may be externally removed from the operating system with relative ease.

The foregoing description has broad application. While the provided examples describe two types of shades, it should be appreciated that the concepts disclosed herein may equally apply to any type of roller shade. Further, while the provided examples describe the bottom stop as being stationary and the top stop as being adjustable, the bottom stop may be adjustable and the top stop may be stationary. Moreover, while the provided examples generally describe a toothed engagement of the members of the top stop, other keying structures may be used. Accordingly, the discussion of any embodiment is meant only to be explanatory and is not intended to suggest that the scope of the disclosure, including the claims, is limited to these examples. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

1. A covering for an architectural opening, comprising:
a head rail;
a first roller rotatably supported by the head rail;
a second roller rotatably supported by the head rail and positioned rearward of the first roller;
a first shade attached to the first roller and wrappable about the first roller, the first shade including two laterally-separable sheets interconnected by a plurality of vertically-spaced vanes; and
a second shade attached to the second roller and wrappable about the second roller.

2. The covering of claim 1, further comprising:
a limit screw positioned within at least one of the first or second rollers; and
a limit stop operably associated with the limit screw, the limit stop including:
a first member threaded onto the limit screw and defining a first keyed structure; and
a second member slidably keyed onto the limit screw and defining a second keyed structure in opposing relationship to, and slidably engagable with, the first keyed structure.

3. The covering of claim 2, wherein the first and second keyed structures comprise corresponding longitudinally-extending splines.

4. The covering of claim 2, wherein the second member includes a resilient, cantilevered finger that selectively engages an external thread of the limit screw.

5. The covering of claim 1, further comprising:
a tube positioned within at least one of the first or second rollers and defining an aperture extending through a wall of the tube; and
a stop element extending at least partially through the aperture.

6. The covering of claim 5, wherein the stop element includes:
a first leg positioned radially between the tube and the at least one of the first or second rollers;
a second leg positioned within the tube; and
a riser extending through the aperture and interconnecting the first and second legs.

7. The covering of claim 6, wherein the first and second legs extend longitudinally along a portion of the tube.

8. The covering of claim 6, wherein the first and second legs extend in opposing directions relative to one another.

9. The covering of claim 1, wherein:
the head rail includes an end cap;
the second shade includes a bottom rail having a flange attached to, and extending longitudinally away from, an end of the bottom rail; and
the flange interacts with the end cap to set a retraction limit of the second shade.

10. The covering of claim 9, wherein:
the end cap includes a cord guide; and
the flange interacts with the cord guide to set the retraction limit of the second shade.

11. The covering of claim 9, wherein the end cap includes a wing positioned rearward of the second shade and extending longitudinally beyond an edge of the second shade.

12. The covering of claim 1, wherein the first and second shades are substantially concealed within the head rail when in a retracted position.

13. The covering of claim 1, wherein the second roller is positioned higher than the first roller within the head rail.

14. A covering for an architectural opening, comprising:
a rotatable roller;
an externally-threaded shaft positioned within the roller;
a travelable nut threaded onto the shaft and keyed to the roller; and
a stop associated with the shaft, the stop including:
an adjustment member threaded onto the shaft and defining a first key pattern; and
a lock member slidably keyed onto the limit screw and defining a second key pattern in opposing relationship to, and slidably engagable with, the first key pattern.

15. The covering of claim 14, wherein the first and second key patterns comprise corresponding longitudinally-extending splines.

16. The covering of claim 15, wherein:
the adjustment member is externally splined; and
the lock member is internally splined.

17. The covering of claim 14 claim 14, 15, or 16, wherein the lock member includes a resilient, cantilevered finger that selectively engages an external thread of the shaft.

18. The covering of claim 14, further comprising an immovable stop, wherein the travelable nut is positioned between the immovable stop and the stop.

19. The covering of claim 14, further comprising a shade suspended from the roller.

20. The covering of claim 19, wherein the shade includes two laterally-separable sheets interconnected by a plurality of vertically-spaced vanes.

21. A covering for an architectural opening, comprising:
an outer tube;
an inner tube positioned within the outer tube and defining an aperture extending through a wall of the tube;
an externally-threaded shaft positioned within the inner tube;
a travelable nut threaded onto the shaft and keyed to the inner tube; and
a stop element positioned within the outer tube and extending at least partially through the aperture.

22. The covering of claim 21, wherein the stop element includes:
a first portion positioned radially between the outer tube and the inner tube;
a second portion positioned within the inner tube; and
an intermediate portion extending through the aperture and interconnecting the first and second portions.

23. The covering of claim 22, wherein the first and second portions extend longitudinally along a length of the inner tube.

24. The covering of claim 22, wherein the first and second portions extend in opposing directions relative to one another.
